(19) United States
(12) Patent Application Publication
(10) Pub. No.: US 2014/0183363 A1
(43) Pub. Date: Jul. 3, 2014

(54) WAVEFRONT MEASURING APPARATUS, WAVEFRONT MEASURING METHOD, AND OBJECT MEASURING APPARATUS

(71) Applicants: Kousuke Kajiki, Tokyo (JP); Toshihiko Ouchi, Machida-shi (JP); Takeaki Itsuji, Hiratsuka-shi (JP)

(72) Inventors: Kousuke Kajiki, Tokyo (JP); Toshihiko Ouchi, Machida-shi (JP); Takeaki Itsuji, Hiratsuka-shi (JP)

(73) Assignee: CANON KABUSHIKI KAISHA, Tokyo (JP)

(21) Appl. No.: 14/119,169

(22) PCT Filed: Apr. 19, 2012
(86) PCT No.: PCT/JP2012/061163

§ 371 Date: Nov. 20, 2013

(30) Foreign Application Priority Data
May 23, 2011 (JP) 2011-114945

(51) Int. Cl. G01B 9/02

(52) U.S. Cl. CPC G01B 9/02
USPC 250/339.07; 356/521

(57) ABSTRACT

The present invention provides a wavefront measuring apparatus and method, and object measuring apparatus which can increase resolution of wavefronts of electromagnetic wave pulses without being limited by the number of detecting elements. An embodiment of the present invention includes a detecting part detecting electric field strength of an electromagnetic wave pulse, and an optical delaying part delaying the electromagnetic wave pulse so as to provide a first propagation path and a second propagation path provided in a spatial region different from a spatial region of the first propagation path and having a length different from a length of the first propagation path, wherein time waveforms of the electromagnetic wave pulse are constructed using a signal associated with the electric field strength detected by the detecting part, and a wavefront is obtained based on the time waveforms and information associated with the lengths of the first and second propagation paths.

### TECHNICAL FIELD

The present invention relates to a wavefront measuring apparatus, wavefront measuring method, and object measuring apparatus used to measure wavefront shapes of electromagnetic wave pulses.

### BACKGROUND ART

Wavefront measuring apparatuses which measure wavefronts of various electromagnetic waves as well as wavefront adjusting apparatuses which adjust the wavefronts of electromagnetic waves using the wavefront measuring apparatus have been developed recently. Such apparatuses find applications in a diverse range of fields including the fields of astronomy and medical imaging. Regarding wavefront measuring apparatuses, measuring apparatuses which use a Shack-Hartmann sensor, shearing interferometer, or wavefront curvature sensor are known generally.

Japanese Patent No. 4249016 discloses a wavefront measuring apparatus capable of measuring a wavefront with high accuracy in a short time using a wavefront measuring scheme of a Shack-Hartmann sensor for the wavefront measuring apparatus. The wavefront measuring apparatus includes a lens array and a two-dimensional detector adapted to convert a focused spot into an image signal, where the focused spot is produced when light to be measured converges by being transmitted through the lens array. The wavefront measuring apparatus finds coordinates of the focused spot using binary center of gravity calculations and computes the wavefront of the light to be measured from the coordinates of the focused spot.

However, the wavefront measuring apparatus described in Patent Literature 1 requires as many detecting elements as resolution (number of divisions) of the wavefront, and consequently the resolution of the wavefront is limited by the number of detecting elements.

### CITATION LIST

### Patent Literature

PTL 1: Japanese Patent No. 4249016

### SUMMARY OF INVENTION

An invention according to a first aspect of the present invention is a wavefront measuring apparatus which measures a wavefront of an electromagnetic wave pulse, comprising: an optical delaying part adapted to delay the electromagnetic wave pulse so as to provide a first propagation path and a second propagation path as propagation paths for the electromagnetic wave pulse, the second propagation path being provided in a region different from a region of the first propagation path and having a length different from a length of the first propagation path; a detecting part adapted to detect a signal associated with electric field strength of the electromagnetic wave pulse delayed by the optical delaying part; a waveform constructing part adapted to construct time waveforms of the electromagnetic wave pulse using the signal associated with the electric field strength detected by the detecting part; and a wavefront obtaining part adapted to obtain the wavefront of the electromagnetic wave pulse based on the time waveforms of the electromagnetic wave pulse and information associated with the lengths of the first and second propagation paths in the optical delaying part.

An invention according to a second aspect of the present invention is a wavefront measuring method for measuring a wavefront of an electromagnetic wave pulse in a wavefront measuring apparatus which comprises an optical delaying part adapted to delay the electromagnetic wave pulse so as to provide a first propagation path and a second propagation path as propagation paths for the electromagnetic wave pulse, the second propagation path being provided in a region different from a region of the first propagation path and having a length different from a length of the first propagation path, and a detecting part adapted to detect a signal associated with electric field strength of the electromagnetic wave pulse delayed by the optical delaying part, the method comprising: obtaining time waveforms of the electromagnetic wave pulse; and measuring a pulse peak time interval between the time waveforms corresponding to the wavefront of the electromagnetic wave pulse in each of regions resulting from division and calculating the pulse peak time interval as a time difference for the each region of the wavefront of the electromagnetic wave pulse.

An invention according to a third aspect of the present invention is a wavefront measuring apparatus which measures a wavefront of an electromagnetic wave pulse by calculating a time difference between various parts of the wavefront of the electromagnetic wave pulse, comprising: an optical delaying part adapted to delay the electromagnetic wave pulse so as to provide a first propagation path and a second propagation path as propagation paths for the electromagnetic wave pulse, the second propagation path being provided in a region different from a region of the first propagation path and having a length different from a length of the first propagation path; a detecting part adapted to detect the electromagnetic wave pulse delayed by the optical delaying part; a processing part adapted to obtain time waveforms of the electromagnetic wave pulse using a detection signal from the detecting part, measure a pulse peak time interval between the time waveforms corresponding to the various parts of the wavefront of the electromagnetic wave pulse, and calculate the pulse peak time interval as the time difference between the various parts of the wavefront of the electromagnetic wave pulse.

An object of the present invention is to provide a wavefront measuring apparatus, wavefront measuring method, and object measuring apparatus which can increase resolution of wavefronts of electromagnetic wave pulses without being limited by the number of detecting elements.

Further features of the present invention will become apparent from the following description of exemplary embodiments with reference to the attached drawings.

### BRIEF DESCRIPTION OF DRAWINGS

FIG. 1 is a diagram showing a configuration example of a wavefront measuring apparatus according to the first embodiment.

FIG. 2A is a diagram illustrating a configuration example of a wavefront adjusting part according to the first embodiment.

FIG. 2B is a diagram illustrating a configuration example of a wavefront adjusting part according to the first embodiment.

FIG. 2C is a diagram illustrating a configuration example of a wavefront adjusting part according to the first embodiment.

FIG. 3 is a flowchart showing a wavefront measuring method according to the first embodiment.

FIG. 4A is an enlarged view of the wavefront adjusting part according to the first embodiment.

FIG. 4B is an enlarged view of the wavefront adjusting part according to the first embodiment.

FIG. 5A is a diagram for illustrating an example of a wavefront measuring method which uses time waveforms.

FIG. 5B is a diagram for illustrating an example of a wavefront measuring method which uses time waveforms.

FIG. 5C is a diagram for illustrating an example of a wavefront measuring method which uses time waveforms.

FIG. 5D is a diagram for illustrating an example of a wavefront measuring method which uses time waveforms.

FIG. 6A is a diagram showing variations of the wavefront measuring apparatus according to the first embodiment.

FIG. 6B is a diagram showing variations of the wavefront measuring apparatus according to the first embodiment.

FIG. 7 is a diagram showing a schematic configuration of an electromagnetic wavefront adjusting apparatus according to the second embodiment.

FIG. 8 is a diagram showing a schematic configuration of an object measuring apparatus according to the third embodiment.

### DESCRIPTION OF EMBODIMENTS

### First Embodiment

A feature of a wavefront measuring apparatus and wavefront measuring method according to the present embodiment is to divide a wavefront of an electromagnetic wave pulse into plural parts and measure the resulting parts in time sequence. That is, the wavefront is divided into plural parts and propagation distance is varied among the parts of the divided wavefront. Consequently, when detecting an electromagnetic wave pulse, a detecting part can detect signals associated with the detected electromagnetic wave pulse in a temporally separated state based on the propagation distance of each part of the wavefront. Specifically, in obtaining time waveforms of the electromagnetic wave pulse, if a time delay ΔT1 is given to each region of the divided wavefront, the time delay ΔT1 varying from one region to another, and a pulse peak time interval ΔT2 between wavefront regions of the electromagnetic wave pulse is measured, ΔT2-ΔT1 can be obtained as a wavefront time difference between two sub-wavefronts. Consequently, since the electromagnetic wave in each region resulting from the division is detected in a temporally separated manner, resolution of the wavefront of the electromagnetic wave pulse can be increased without being limited by the number of detecting elements.

Furthermore, when an electromagnetic wave pulse has a small wavefront deviation, making it difficult to accurately measure a deviation amount, a time delay ΔT1 larger than a pulse time width of the electromagnetic wave pulse may be provided among sub-wavefronts using a wavefront adjusting part adapted to adjust the propagation distance of each region resulting from division. That is, if ΔT1 is increased, the time waveforms of the electromagnetic wave pulses can be temporally separated easily so as not to overlap one another at the resulting sub-wavefronts. Embodiments of the present invention will be described in detail below with reference to the accompanying drawings.

### (Configuration of Wavefront Measuring Apparatus)

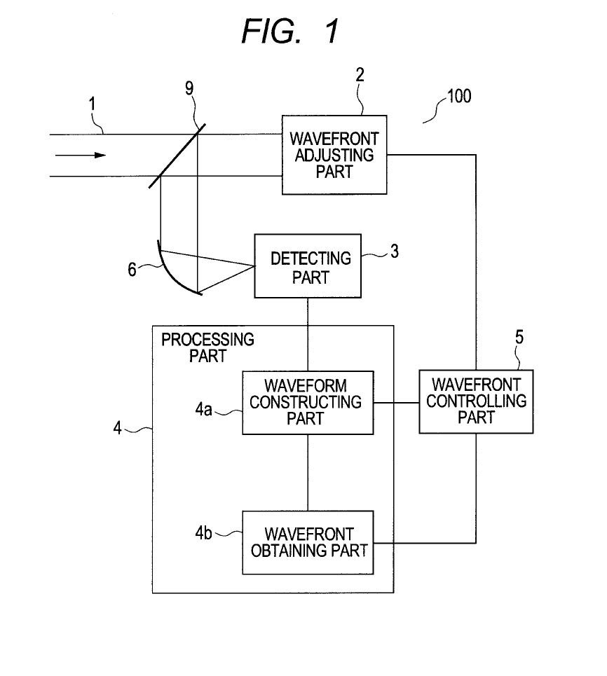

The wavefront measuring apparatus according to the present embodiment will be described with reference to FIG. 1. FIG. 1 is a diagram showing a schematic configuration of the wavefront measuring apparatus 100. The wavefront measuring apparatus 100 includes a detecting part 3 adapted to detect electromagnetic wave pulses and a wavefront adjusting part 2 which is an optical delaying part adapted to delay the electromagnetic wave pulses reaching the detecting part 3 and thereby provide a first propagation path and second propagation path as propagation paths for the electromagnetic wave pulses. Also, the wavefront measuring apparatus 100 includes a focusing part 6 adapted to focus electromagnetic wave pulses onto the detecting part 3, a wavefront controlling part 5, and a processing part 4 adapted to measure and process the wavefronts of the electromagnetic wave pulses using signals detected by the detecting part 3. Furthermore, the wavefront measuring apparatus 100 includes a beam splitter 9 adapted to transmit and reflect electromagnetic wave pulses.

The processing part 4 includes a waveform constructing part 4a adapted to construct time waveforms of electromagnetic wave pulses using signals associated with electric field strength of the electromagnetic wave pulses detected by the detecting part 3 and a wavefront obtaining part 4b adapted to obtain wavefronts of the electromagnetic wave pulses based on the time waveforms of the electromagnetic wave pulses and information associated with lengths of the first and second propagation paths, where the information is provided by the wavefront adjusting part 2.

As shown in FIG. 1, an electromagnetic wave pulse 1 is transmitted through the beam splitter 9 and reflected by the wavefront adjusting part 2. Then, via the beam splitter 9 and focusing part 6, electromagnetic wave pulse 1 reaches the detecting part 3 adapted to detect the electric field strength of the electromagnetic wave pulse. Reflecting surfaces of the focusing part 6 are shaped such that propagation distances of the electromagnetic wave pulse to the detecting part will be equal among the reflecting surfaces, i.e., such that the propagation paths of the wavefront of the electromagnetic wave pulse from the wavefront adjusting part 2 to the detecting part 3 via the beam splitter 9 and focusing part 6 will be equal excluding propagation distances given by the wavefront adjusting part 2 to different spatial regions. However, the propagated electromagnetic wave pulses 1 may have any shape and the electromagnetic wave may be propagated in parallel or may converge or diverge.

### (Wavefront Adjusting Part)

The wavefront adjusting part 2 divides the wavefront of the electromagnetic wave pulse 1 into regions and give propagation paths of different lengths to the sub-wavefronts of the electromagnetic wave pulse in the resulting regions. According to the present embodiment, the electromagnetic wave pulse 1 is divided into at least two or more regions and at least a first propagation path and second propagation path are given to the electromagnetic wave pulse 1. The wavefront of an electromagnetic wave pulse 1 herein means a plane obtained by continuously linking peak values of the electric field intensity of the electromagnetic wave pulse at a given time point. Also, wavefront division is the act of spatially dividing a wavefront into plural parts in a plane.

The wavefront adjusting part 2 delays the electromagnetic wave pulse such that different regions will have propagation paths of different lengths. Desirably, a deformable mirror or segmented mirror which can continuously or discontinuously change reflecting surfaces for electromagnetic wave pulses is used as the wavefront adjusting part 2. Also, a reflecting mirror or segmented mirror to which reflecting surfaces are fixed continuously or discontinuously may be used alternatively. In that case, desirably the mirror is configured to be tiltable or rotatable in order to allow length (propagation distance) of the propagation path given to each spatial region to be adjusted variably.

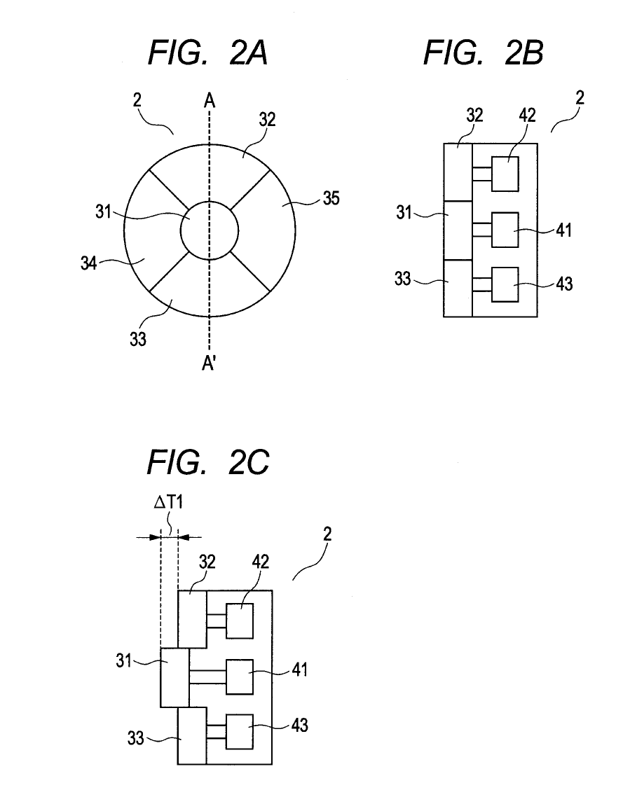

FIGS. 2A to 2C are diagrams showing a configuration example of the wavefront adjusting part 2. FIG. 2A is a diagram showing the wavefront adjusting part 2 as viewed along a propagation direction of the electromagnetic wave pulses 1 while FIGS. 2B and 2C are sectional views taken along line A-A′ of FIG. 2A. The wavefront adjusting part 2 includes mirror segments 31, 32, 33, 34 and 35. Furthermore, the wavefront adjusting part 2 includes actuators 41, 42 and 43 which are drive units adapted to drive the mirrors in such a way as to make mirror positions variable.

As shown in FIGS. 2A and 2B, according to the present embodiment, the wavefront is divided into five regions and a mirror and actuator are placed in each of the regions. Each mirror (31, 32, 33, 34 or 35) is configured to be able to move parallel to a propagation direction of the electromagnetic wave pulses so as to be able to move accurately along the length (propagation distance) of the propagation path in each region resulting from division.

When a segmented mirror is used as in the case of the present embodiment, two or more is enough as the numbers of mirror segments and actuators, and from the perspective of increasing spatial resolution by dividing the wavefront of the electromagnetic wave pulse into a larger number of parts, five or more is desirable.

FIG. 2C is a diagram showing how the mirror 31 has been moved by operating the actuator 41. In this way, by moving the mirror 31 by a length corresponding to a time ΔT1, length of the propagation path (length of the first propagation path) via the mirror 31 can be reduced by 2×ΔT1 compared to length of the propagation path (length of the second propagation path) via the mirrors 32 and 33. Consequently, when electromagnetic wave pulses are detected by the detecting part 3, a time delay of 2×ΔT1 is given to the electromagnetic wave pulse reflected by the mirrors 32 and 33 compared to the electromagnetic wave pulse reflected by the mirror 31.

Incidentally, the wavefront adjusting part 2 may be configured to be able to move all the reflecting surfaces all together without dividing the wavefront into regions to enable constructing time waveforms using time-domain spectroscopy. Details will be described later.

### (Construction of Time Waveforms of Electromagnetic Wave Pulse)

The detecting part 3 configured to detect electromagnetic waves detects information associated with the electric field strength (electric field intensity) of the electromagnetic wave pulse 1. The processing part 4 constructs time waveforms of the electromagnetic wave pulse 1 using a detection signal transmitted from the detecting part 3 and also obtains a wavefront of the electromagnetic wave pulse. The wavefront controlling part 5 variably controls a wavefront division pattern of the electromagnetic wave pulse 1 produced by the wavefront adjusting part 2 as well as propagation distances given to the sub-wavefronts resulting from division.

### (Principles of Wavefront Measurement)

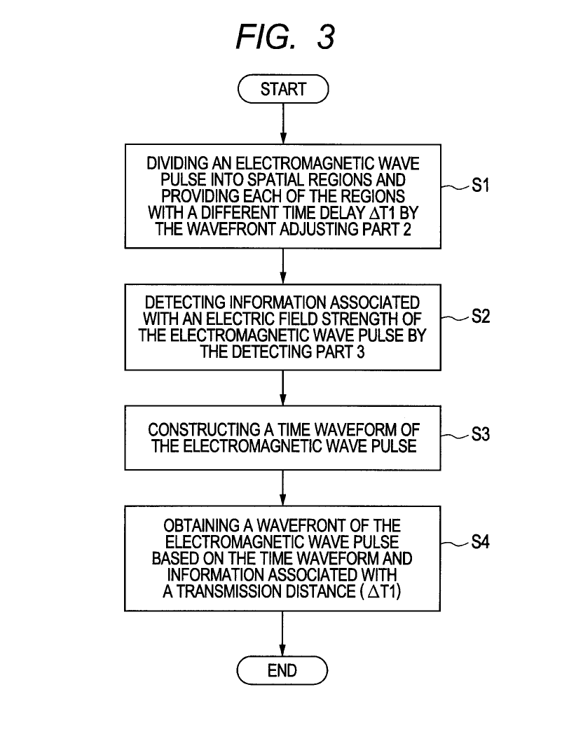

Principles of wavefront measurement according to the present embodiment will be described below with reference to FIGS. 3, 4A to 4B and 5A to 5D.

FIG. 3 is a flowchart showing the wavefront measuring method for electromagnetic wave pulses on the wavefront measuring apparatus 100 according to the present embodiment. On the wavefront measuring apparatus 100 according to the present embodiment, steps of the wavefront measuring method for electromagnetic wave pulses correspond to the following processes.

Desirably, the electromagnetic wave pulses used are in the so-called terahertz wave frequency band including a frequency band ranging from 30 GHz to 30 THz. By using a terahertz wave, the present embodiment is expected to be applied to imaging related to moisture content and other physical properties of samples, observation of cancer cell, and so on.

Measurement is started by irradiating a sample with an electromagnetic wave pulse. First, the wavefront adjusting part 2 divides the electromagnetic wave pulse into plural regions and gives a different time delay ΔT1 (propagation distance) to each of the resulting regions (step S1). The detecting part 3 detects information associated with the electric field strength of the electromagnetic wave pulse (step S2). Time waveforms of the electromagnetic wave pulse 1 are constructed (step S3). A wavefront of the electromagnetic wave pulse is obtained based on the time waveforms of the divided electromagnetic wave pulse 1 and information (time delay ΔT1 provided) associated with the propagation distances (lengths of propagation paths) adjusted by the wavefront adjusting part 2 (step S4).

The processes of S1 to S4 described above enable obtaining a time waveform of the electromagnetic wave pulse in each of the regions resulting from the division and thereby obtaining the wavefront of the electromagnetic wave pulse based on the obtained time waveforms. The principles of wavefront measurement according to the present embodiment will be described in more detail below.

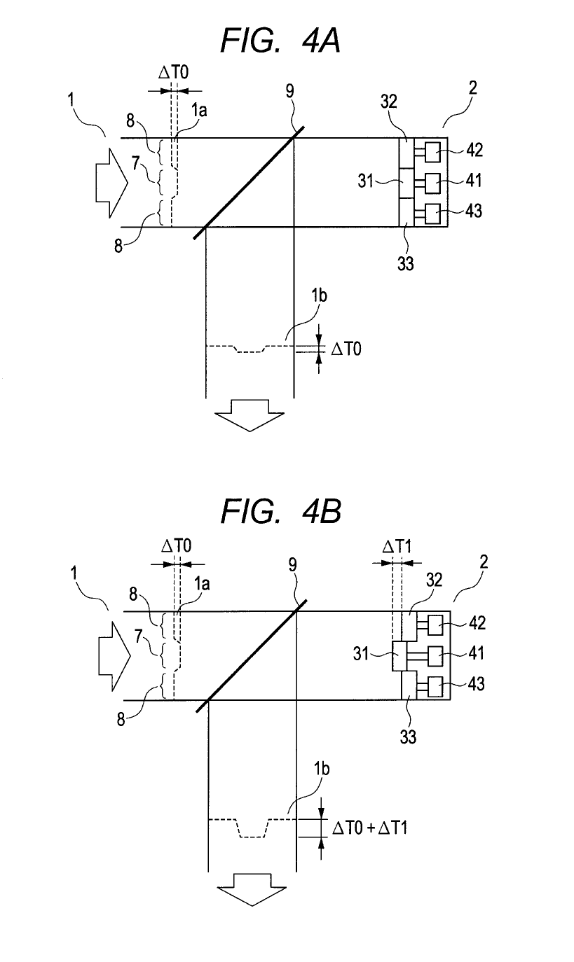

FIGS. 4A and 4B are enlarged views of the wavefront adjusting part, showing a wavefront of the electromagnetic wave pulse 1a before reflection upstream of the wavefront adjusting part 2 along the propagation direction of the electromagnetic wave pulse and a wavefront of the electromagnetic wave pulse 1b after reflection downstream of the wavefront adjusting part 2 along the propagation direction of the electromagnetic wave pulse. In FIG. 4A, the reflecting surfaces of the mirrors 31, 32 and 33 in the wavefront adjusting part 2 are located on the same plane, while in FIG. 4B, the mirror 32 is moved ΔT1 from the aforementioned plane.

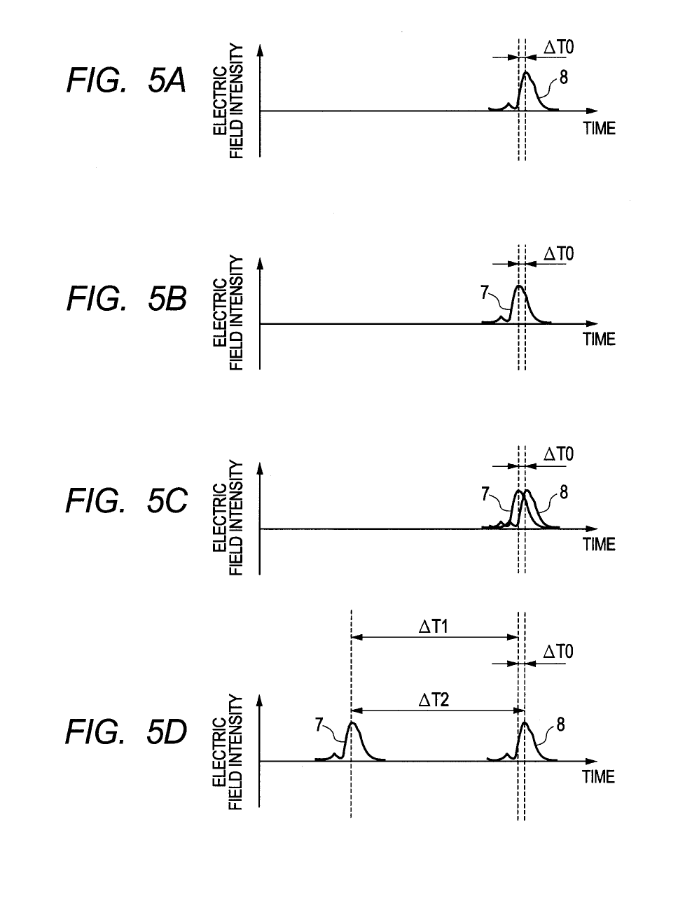

FIGS. 5A to 5D are diagrams for illustrating an example of a wavefront measuring method which uses time waveforms. FIG. 5A is a diagram showing a time waveform in central part 7 of the electromagnetic wave pulse 1, FIG. 5B is a diagram showing a time waveform in peripheral part 8 of the electromagnetic wave pulse, FIG. 5C is a diagram showing time waveforms in the case where the central part 7 and peripheral part 8 of the electromagnetic wave pulse are detected as being superimposed on each other, and FIG. 5D is a diagram showing time waveforms in the case where the central part 7 and peripheral part 8 of the electromagnetic wave pulse are detected as being separated from each other.

First, as shown in FIG. 4A, suppose, for example, before being reflected in the wavefront adjusting part 2, the wavefront of the electromagnetic wave pulse 1a is such that the central part 7 of the wavefront of the electromagnetic wave pulse 1a is temporally ahead of the peripheral part 8 and that a peak of the electromagnetic wave pulse in the central part 7 is located downstream of the peripheral part 8 along the propagation direction of the electromagnetic wave pulse.

It is assumed here that a time difference ΔT0 between the central part 7 and peripheral part 8 of the wavefront is 100 fs and that a pulse width (the pulse width herein is an FWHM (Full Width at Half Maximum) of the electric field intensity) of the electromagnetic wave pulse 1 is 400 fs.

In FIG. 4A, since the wavefront adjusting part 2 is on a single plane, the electromagnetic wave pulse 1 does not have its wavefront shape changed before and after being reflected by the wavefront adjusting part 2. Therefore, the wavefront of the electromagnetic wave pulse 1b maintains ΔT0=100 fs when the electromagnetic wave pulse reaches the detecting part 3. At this time, as shown in FIG. 5, the time waveform (FIG. 5A) in the central part 7 and time waveform (FIG. 5B) in the peripheral part 8 of the electromagnetic wave pulse 1 are detected by the detecting part 3 as being temporally superimposed on each other (FIG. 5C). Generally, when time waveforms are superimposed in this way, it is difficult to accurately determine a time difference between peak positions of the electric field intensities on the wavefronts corresponding to the time waveforms of the central part 7 and peripheral part 8 of the electromagnetic wave pulse 1.

On the other hand, in FIG. 4B, since the mirror 31 protrudes from the other mirrors 32 and 33 of the wavefront adjusting part 2 as illustrated, the electromagnetic wave pulse 1b has its wavefront shape changed after reflection off the mirrors. If protrusion length of the center mirror 31 is, for example, 60 μm, a length of a propagation path (a first propagation path) of a beam in the central part 7 of the electromagnetic wave pulse 1b, i.e., a first propagation distance, is 120 μm (which corresponds to ΔT1=400 fs) shorter than a length of a propagation path (a second propagation path) of a beam in the peripheral part 8, i.e., a second propagation distance. Therefore, if time waveforms are constructed in these conditions, major parts (having high electric field intensities) of time waveforms of the central part 7 and peripheral part 8 of the electromagnetic wave pulse 1 can be detected in a temporally separated manner as shown in FIG. 5D.

This makes it easy to measure a time difference between peak positions of the electric field intensities.

To measure the pulse peak time interval with high temporal accuracy by temporally separating the central part 7 and peripheral part 8 of the electromagnetic wave pulse clearly, desirably ΔT1 which is a time delay corresponding to the difference between the lengths of the first and second propagation paths is equal to or larger than the pulse time width of the electromagnetic wave pulse 1. That is, desirably ΔT1 is equal to or larger than 400 fs, which is the pulse width of the electromagnetic wave pulse 1 according to the present embodiment. However, the time delay ΔT1 corresponding to the difference between the lengths of the first and second propagation paths should not exceed measured time width of the time waveform of the electromagnetic wave pulse 1. Generally, the larger the measured time width, the easier it is to separate pulses, but the longer it takes to measure the wavefront. The trade-off between the ease of pulse separation and the length of wavefront measuring time can be determined based on system demand.

If a peak-to-peak interval between wavefronts corresponding to regions of a measured electromagnetic wave pulse is designated as the pulse peak time interval ΔT2, a time difference (time difference between electric field intensity peaks, wavefront deviation amount) ΔT0 between time waveforms corresponding to the central part 7 and peripheral part 8 of the electromagnetic wave pulse 1 (i.e., electromagnetic wave pulse 1a before reflection) can be calculated using Eq. 1 below.

ΔT2−ΔT1=ΔT0 Eq. 1

If measurement of the wavefront deviation amount in each spatial region is repeated for each sub-wavefront using Eq. 1, state of the wavefront of the electromagnetic wave pulse 1a can be measured on a region by region basis. The division pattern and number of divisions of wavefront can be arbitrary. However, if the regions resulting from division are too small, diffraction has a large impact, resulting in an increase in components which cannot be focused on the detecting part 3. Therefore, desirably size (resolution) of the regions produced by division is larger than a maximum wavelength of wavelength components contained in the electromagnetic wave pulse 1.

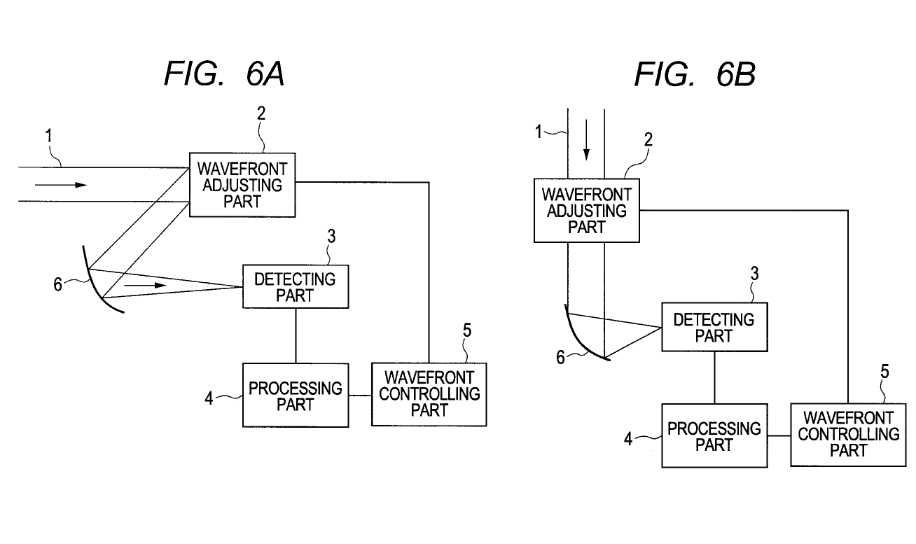

FIGS. 6A and 6B show variations of the wavefront measuring apparatus described in the present embodiment. As shown in FIG. 6A, an incident angle of the electromagnetic wave pulse 1 with respect the wavefront adjusting part 2 may be tilted from a direction perpendicular to a reflecting surface. This configuration has the advantage of obviating the need for the beam splitter 9.

As shown in FIG. 6B, the wavefront adjusting part 2 may be a propagation type. For example, the wavefront may be divided by varying the propagation distance from region to region using a liquid lens or the like. Also, a glass or plastic plate whose surface is provided with a concavo-convex pattern may be inserted during wavefront measurement to give a different propagation path to each sub-wavefront to be produced by division. When such a propagation-type wavefront adjusting part 2 is used, desirably a substance highly transparent to electromagnetic wave pulses 1 is used as a material for the wavefront adjusting part 2.

Incidentally, although cases in which the detecting part 3 is equipped with a single detecting element have been described so far, the detecting part 3 may be equipped with plural detecting elements. In that case, the detecting elements may be arranged in a line or in an array. However, the number of detecting elements is smaller than the number of regions resulting from division (resolution).

If the electric field strength of the electromagnetic wave pulse is detected in a shared manner among plural detecting elements and the wavefront is measured subsequently, increases in the time required to measure the wavefront of the electromagnetic wave pulse can be curbed.

### Second Embodiment

A feature of the present embodiment is a step of comparing the wavefront of the electromagnetic wave pulse 1 with any predetermined target wavefront and bringing the wavefront of the electromagnetic wave pulse 1 close to the predetermined wavefront by variably controlling the length of the propagation path in each region of the wavefront adjusting part 2. The rest of the configuration is substantially the same as the first embodiment, and thus will be omitted in the following description.

### (Configuration of Wavefront Measuring Apparatus)

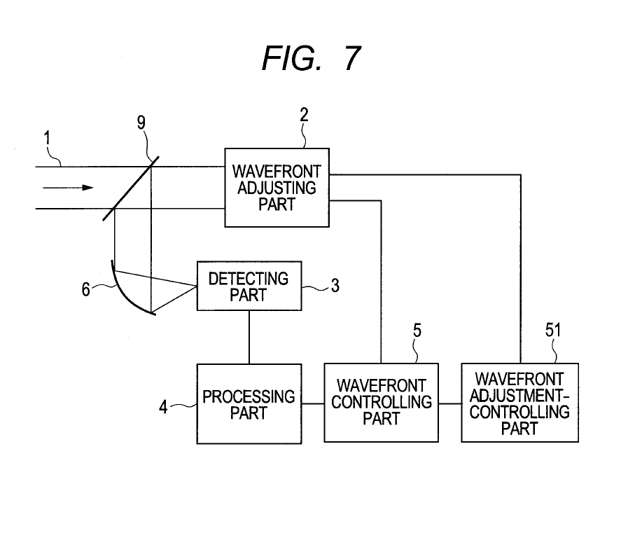

FIG. 7 is a diagram showing a schematic configuration of a wavefront measuring apparatus (or an electromagnetic wavefront adjusting apparatus) of an electromagnetic wave pulse according to the present embodiment. According to the present embodiment, a wavefront adjustment-controlling part 51 is added to the configuration according to the first embodiment. The wavefront adjustment-controlling part 51 variably controls the length of the propagation path by moving the wavefront adjusting part 2 and performs control so as to bring a detected wavefront of the electromagnetic wave pulse 1 into coincidence with the predetermined wavefront.

A step of adjusting the wavefront of an electromagnetic wave pulse according to the present embodiment is largely divided into two parts. A first step involves measuring the wavefront of the electromagnetic wave pulse 1. The measuring method described in the first embodiment can be used for the first step.

A second step involves comparing the wavefront of the electromagnetic wave pulse 1 measured in the first step with any predetermined target wavefront and bringing the wavefront of the electromagnetic wave pulse 1 close to the predetermined wavefront (ideal wavefront) by variably controlling the length of the propagation distance in each region of the wavefront adjusting part 2 using the wavefront adjustment-controlling part 51.

The predetermined wavefront is determined arbitrarily. For example, the predetermined wavefront may be such as to make the measured wavefront of the electromagnetic wave pulse planar or spherical. Also, the predetermined wavefront may be calculated using optical simulations or a wavefront measured at some point may be set as a predetermined wavefront. It can also be determined arbitrarily how close the measured wavefront should be brought to the predetermined wavefront. In the present embodiment, the closeness is set to 1/10 the pulse width of the electromagnetic wave pulse 1 to restrain the pulse width of the electromagnetic wave pulse 1 from broadening, but may be set as appropriate depending on the product.

The second step involves moving the mirrors 31 to 35 of the wavefront adjusting part 2 by a propagation distance corresponding to a time difference which represents a wavefront deviation amount (difference from the predetermined wavefront) obtained in the first step. For example, if the wavefront deviation amount represented by the time difference between parts A and B on the wavefront is 30 fs, corresponding parts in the wavefront adjusting part 2 can be shifted from each other by 5 μm along an optical axis (however this applies when the wavefront adjusting part 2 is a reflection type).

The wavefront adjusting part 2 will require a large difference in the propagation distance of the propagation path between sub-wavefronts in some cases as with the first step, and a difference as small as, for example, a few μm in the propagation distance of the propagation path in other cases as with the second step. For this reason, two types of actuators may be provided to suit movable ranges and positional accuracies of respective cases.

For more accurate wavefront compensation, desirably the location of the wavefront adjusting part 2 is optically conjugate to a location of aberration. Plural wavefront adjusting parts 2 may be provided along the optical axis for the electromagnetic wave pulse 1. If locations to which placement locations of the plural wavefront adjusting parts 2 are optically conjugate are different from one another, it becomes easy to compensate for wavefront deviations occurring at the different locations.

Due to disturbance of the wavefront, the detected electromagnetic wave pulse 1 will undergo reduction of power or broadening of pulse width. This is because various parts of the wavefront will spatially spread or lag in time when reaching the detecting part 3. The configuration according to the present embodiment can reduce the impact of aberrations, improve detection capacity, and limit the broadening of pulse width.

### Third Embodiment

A feature of the present embodiment is that the wavefront measuring apparatus according to the first or second embodiment is applied to an object measuring apparatus 200 which measures objects using terahertz time-domain spectroscopy. The configuration of the wavefront measuring apparatus is substantially the same as the first embodiment, and thus will be omitted in the following description.

### (Object Measuring Apparatus)

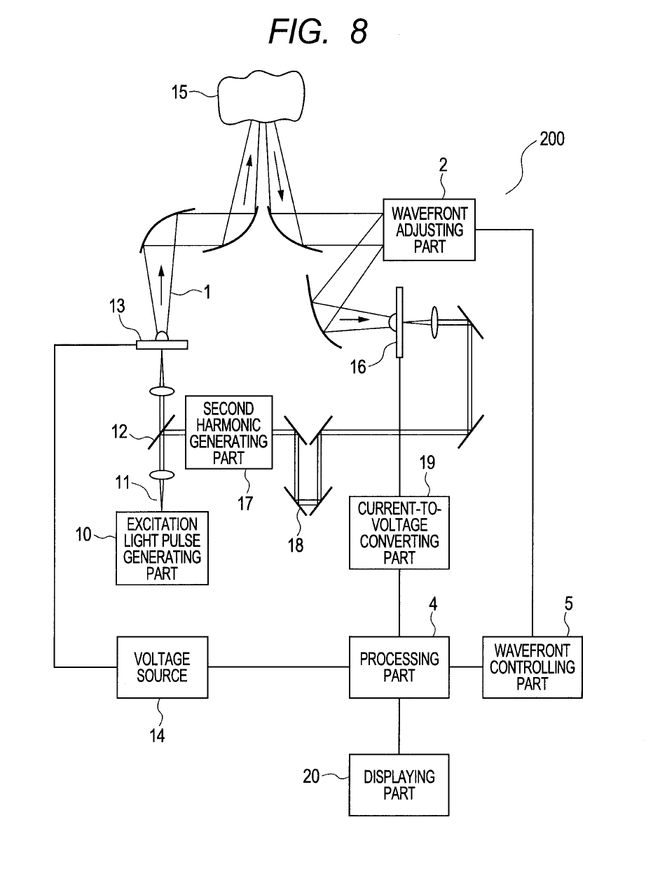

FIG. 8 is a diagram showing a schematic configuration of the object measuring apparatus 200 according to the present embodiment. The object measuring apparatus 200 according to the present embodiment is a configuration example in which the above-described wavefront measurement is applied to a measuring apparatus based on THz-TDS (Terahertz Time Domain Spectroscopy) which uses the terahertz wave frequency band including electromagnetic components in a frequency domain ranging from about 30 GHz to 30 THz.

In FIG. 8, an excitation light pulse generating part 10 adapted to generate excitation light pulses emits excitation light pulses 11. The excitation light pulse generating part 10 can use fiber laser and the excitation light pulses 11 are laser pulses with a wavelength in the 1.5 μm band and a pulse time width (FWHM in electric field intensity display) of about 30 fs.

The excitation light pulses 11 are bifurcated by a beam splitter 12. One branch of excitation light pulses 11 enters an electromagnetic wave pulse generating element 13 which is an electromagnetic wave pulse generating part and the other branch of the excitation light pulses 11 enters a second harmonic generating part 17.

The electromagnetic wave pulse generating element 13 which is an electromagnetic wave pulse generating part includes a photoconductive element and a hemispherical silicon lens. The photoconductive element includes a photoconductive layer adapted to absorb the excitation light pulses 11 and generate photoexcited carriers, an electrode adapted to apply an electric field to the photoconductive layer, and an antenna adapted to radiate generated electromagnetic wave pulses 1.

The electromagnetic wave pulses 1 are generated when the photoexcited carriers are accelerated by an electric field. The electromagnetic wave pulses 1 are radiated intensely toward the back side of a substrate where the photoconductive element is formed, and so the hemispherical silicon lens is placed on the back side of the substrate to enhance power radiated into space.

Since it is assumed here that the wavelength of the excitation light pulses 11 is in the 1.5 μm band, low-temperature-grown InGaAs which absorbs excitation light at this wavelength and generates photoexcited carriers can be used as the photoconductive layer. A voltage source 14 applies a voltage to the electrode of the photoconductive element. The above configuration generally enables radiating electromagnetic wave pulses 1 with up to about a pulse time width (FWHM in electric field intensity display) of a few 100 fs in a frequency domain of a few THz.

The electromagnetic wave pulses 1 radiated into space are focused and directed at a sample 15 by optical elements such as lenses and mirrors. The electromagnetic wave pulses 1 reflected off the sample 15 enter the wavefront adjusting part 2. After being reflected by the wavefront adjusting part 2, the electromagnetic wave pulses 1 enter an electromagnetic wave pulse detecting element 16. Incidentally, the electromagnetic wave pulse detecting element 16 may be configured to detect the electromagnetic wave pulses 1 which propagate the sample 15 or wavefront adjusting part 2.

The second branch of excitation light pulses 11 which enters a second harmonic generating part 17 after being split by the beam splitter 12 is converted into a pulsed laser with a wavelength in the 0.8 μm band by a second harmonic conversion process. A PPLN (Periodically Poled Lithium Niobate) crystal or the like can be used as a second harmonic conversion element. Wavelengths produced in other non-linear processes and laser with a wavelength in the 1.5 μm band emitted without being wavelength-converted are normally removed from the excitation light pulses 11 by a dichroic mirror or the like. After being converted into a wavelength in the 0.8 μm band, the excitation light pulses 11 enter the electromagnetic wave pulse detecting element 16 by passing through an excitation light delay system 18. A photoconductive element and hemispherical silicon lens with a configuration similar to that of the electromagnetic wave pulse generating element 13 can be used as the electromagnetic wave pulse detecting element 16. However, to absorb the excitation light pulses 11 in the 0.8 μm band, low-temperature-grown GaAs is used suitably for the photoconductive layer. The photoexcited carriers generated in the photoconductive layer are accelerated by an electric field of the electromagnetic wave pulses 1 to generate a current between electrodes until trapped.

The current is converted into a voltage by a current-to-voltage converting part 19. The voltage value reflects the electric field intensity of the electromagnetic wave pulses 1 during a period (generally set to a time scale shorter than the pulse time width of the electromagnetic wave pulses 1) in which a photocurrent flows. The time waveforms of the electric field intensity of the electromagnetic wave pulses 1 can be reconstructed by sweeping a delay time of the excitation light pulses 11 using the excitation light delay system 18. From the time waveforms of the divided electromagnetic wave pulse 1 thus obtained as well as from frequency components thereof, the processing part 4 acquires sample information (complex refractive index, shape, tomographic images and the like) and displays the sample information on a displaying part 20.

The wavefronts of the electromagnetic wave pulses 1 contain aberrations caused by various factors. For example, aberrations are produced by the sample 15 itself, disturbance of ambient gas on an optical path, and the optical element until the electromagnetic wave pulses 1 reach a measurement site in the sample 15. The wavefront controlling part 5 adjusts the wavefronts of the electromagnetic wave pulses 1 by controlling the wavefront adjusting part 2. A wavefront measuring step and wavefront adjusting step can be carried out in the manner described in the first and second embodiments. Since the wavelength of terahertz waves is about 300 μm (at a frequency of 1 THz), if the size of sub-wavefronts in the wavefront adjusting part 2 is a few mm or above, the impact of diffraction effects can be kept down. For example, if beam size of the electromagnetic wave pulses 1 is 50 mm in diameter, the size of sub-wavefronts can be set to 10 mm.

Lock-in detection may be performed after the voltage to be applied to the electromagnetic wave pulse generating element 13 is subjected to voltage modulation of about a few 10 kHz. In observation of a measurement site in a swinging object (liquid, powder, or human body), if wavefront compensation of the electromagnetic wave pulses 1 is repeated in pace with a time scale of the swing, measurements can be taken with high accuracy by reducing temporal noise fluctuations.

By bringing the wavefront close to a targeted ideal wavefront by making adjustments using the wavefront adjusting part 2 with a mirror placed at the location of the sample 15, the amount of wavefront adjustment of the wavefront adjusting part 2 thus determined may be used subsequently in measurement of the sample 15. This will allow information associated with the sample 15 itself (including aberrations caused by the sample) to be measured by reducing aberrations caused by factors other than the sample 15.

The wavefront obtained when a mirror is placed at the location of the sample 15 may be designated as an ideal wavefront. Consequently, aberrations caused by the sample 15 itself can be reduced during wavefront adjustment with the sample 15 installed.

The wavefront adjusting part 2 is placed between the sample 15 and electromagnetic wave pulse detecting element 16 in the above example, but may be placed between the electromagnetic wave pulse generating element 13 and sample 15. In this case, first, by replacing the sample 15 with a plane mirror free from aberrations, the wavefront of the electromagnetic wave pulse 1 is measured. This enables measuring the wavefront deviation between the electromagnetic wave pulse generating element 13 and wavefront adjusting part 2 without being affected by the sample 15. In this state, measurements are not free from the impact of aberration-causing factors (e.g., aberration caused by an atmosphere on the optical path subsequent to the wavefront adjusting part 2) other than the sample. By performing a wavefront measurement in this arrangement and reducing disturbance of the wavefront before incidence on the sample 15, evaluation of the sample with higher accuracy becomes possible.

The above configuration allows an object to be evaluated with high accuracy using electromagnetic wave pulses with reduced aberrations.

While the present invention has been described with reference to exemplary embodiments, it is to be understood that the present invention is not limited to the disclosed exemplary embodiments and that various modifications and changes can be made within the scope of the invention.

This application claims the benefit of Japanese Patent Application No. 2011-114945, filed May 23, 2011, which is hereby incorporated by reference herein in its entirety.

1. A wavefront measuring apparatus which measures a wavefront of an electromagnetic wave pulse, comprising:
an optical delaying part adapted to delay the electromagnetic wave pulse so as to provide a first propagation path and a second propagation path as propagation paths for the electromagnetic wave pulse, the second propagation path being provided in a region different from a region of the first propagation path and having a length different from a length of the first propagation path;
a detecting part adapted to detect a signal associated with electric field strength of the electromagnetic wave pulse delayed by the optical delaying part;
a waveform constructing part adapted to construct time waveforms of the electromagnetic wave pulse using the signal associated with the electric field strength detected by the detecting part; and
a wavefront obtaining part adapted to obtain the wavefront of the electromagnetic wave pulse based on the time waveforms of the electromagnetic wave pulse and information associated with the lengths of the first and second propagation paths in the optical delaying part.

2. The wavefront measuring apparatus according to claim 1, further comprising:
a controlling part adapted to variably control the lengths of the propagation paths such that a difference between the length of the first propagation path and the length of the second propagation path will be equivalent to a time delay ΔT1.

3. The wavefront measuring apparatus according to claim 1, wherein
the wavefront obtaining part obtains ΔT2−ΔT1 as the wavefront of the electromagnetic wave pulse based on a time delay ΔT1 equivalent to the difference between the length of the first propagation path and the length of the second propagation path as well as on a pulse peak time interval ΔT2 between the time waveforms of the wavefront corresponding to the first and second propagation paths.

4. The wavefront measuring apparatus according to claim 2, wherein
the time delay ΔT1 is equal to or larger than a pulse time width of the electromagnetic wave pulse.

5. The wavefront measuring apparatus according to claim 1, further comprising:
a controlling part adapted to variably control the lengths of the propagation paths so as to bring the wavefront of the electromagnetic wave pulse obtained by the wavefront obtaining part close to a predetermined wavefront by comparing the wavefront of the electromagnetic wave pulse with the predetermined wavefront.

6. The wavefront measuring apparatus according to claim 1, wherein
the detecting part includes a smaller number of detecting elements than the number of divisions of a divided wavefront of the electromagnetic wave pulse.

7. The wavefront measuring apparatus according to claim 1, wherein
each of regions of a divided wavefront of the electromagnetic wave pulse is larger than a maximum wavelength of the electromagnetic wave pulse.

8. The wavefront measuring apparatus according to claim 1, wherein
the electromagnetic wave pulse includes a frequency band ranging from 30 GHz to 30 THz.

9. The wavefront measuring apparatus according to claim 2, wherein
the waveform constructing part forms the time waveforms of the electromagnetic wave pulse based on the information associated with the propagation path lengths variably controlled by the controlling part as well as on the signal associated with the electric field strength.

10. An object measuring apparatus which measures an object using terahertz time-domain spectroscopy, comprising:
a generating part adapted to generate an electromagnetic wave pulse including a frequency band ranging from 30 GHz to 30 THz and irradiate a sample with the electromagnetic wave pulse; and
the wavefront measuring apparatus according to claim 1, the wavefront measuring apparatus being adapted to measure the electromagnetic wave pulse after irradiation of the sample by the generating part.

11. A wavefront measuring apparatus which measures a wavefront of an electromagnetic wave pulse by calculating a time difference between various parts of the wavefront of the electromagnetic wave pulse, comprising:
an optical delaying part adapted to delay the electromagnetic wave pulse so as to provide a first propagation path and a second propagation path as propagation paths for the electromagnetic wave pulse, the second propagation path being provided in a region different from a region of the first propagation path and having a length different from a length of the first propagation path;
a detecting part adapted to detect the electromagnetic wave pulse delayed by the optical delaying part;
a processing part adapted to obtain time waveforms of the electromagnetic wave pulse using a detection signal from the detecting part, measure a pulse peak time interval between the time waveforms corresponding to the various parts of the wavefront of the electromagnetic wave pulse, and calculate the pulse peak time interval as the time difference between the various parts of the wavefront of the electromagnetic wave pulse.

12. The wavefront measuring apparatus according to claim 11, further comprising:
a controlling part adapted to divide the wavefront of the electromagnetic wave pulse and control the lengths of the propagation paths so as to provide a time delay ΔT1 between at least two sub-wavefronts resulting from the division, wherein
the processing part obtains time waveforms of the electromagnetic wave pulse, measures a pulse peak time interval ΔT2 between the time waveforms corresponding to various parts of the wavefront of the electromagnetic wave pulse provided with the time delay ΔT1, and calculates ΔT2−ΔT1 as the time difference between the various parts of the wavefront of the electromagnetic wave pulse.

13. The wavefront measuring apparatus according to claim 1, wherein
the time delay ΔT1 is equal to or larger than a pulse time width of the electromagnetic wave pulse.

14. The wavefront measuring apparatus according to claim 1, further comprising:
a controlling part adapted to control so as to bring the wavefront of the electromagnetic wave pulse closer to a targeted ideal wavefront by comparing the wavefront of the electromagnetic wave pulse with the ideal wavefront.

15. A wavefront measuring method for measuring a wavefront of an electromagnetic wave pulse in a wavefront measuring apparatus which comprises an optical delaying part adapted to delay the electromagnetic wave pulse so as to provide a first propagation path and a second propagation path as propagation paths for the electromagnetic wave pulse, the second propagation path being provided in a region different from a region of the first propagation path and having a length different from a length of the first propagation path, and a detecting part adapted to detect a signal associated with electric field strength of the electromagnetic wave pulse delayed by the optical delaying part, the method comprising:
obtaining time waveforms of the electromagnetic wave pulse; and
measuring a pulse peak time interval between the time waveforms corresponding to the wavefront of the electromagnetic wave pulse in each of regions resulting from division and calculating the pulse peak time interval as a time difference for the each region of the wavefront of the electromagnetic wave pulse.

16. The wavefront measuring method according to claim 15, wherein
the obtaining time waveforms includes dividing the wavefront of the electromagnetic wave pulse and providing a time delay ΔT1 between at least two sub-wavefronts, and obtaining time waveforms of the divided electromagnetic wave pulse and measuring a pulse peak time interval ΔT2 between the time waveforms for each of the sub-wavefronts of the electromagnetic wave pulse provided with the time delay ΔT1, and
the calculating includes calculating ΔT2−ΔT1 as a wavefront deviation amount of the divided electromagnetic wave pulse.

17. The wavefront measuring method according to claim 15, further comprising:
comparing the wavefront of the electromagnetic wave pulse with a targeted ideal wavefront; and
dividing the wavefront of the electromagnetic wave pulse and bringing the wavefront closer to the ideal wavefront by adjusting the propagation path of each of sub-wavefronts resulting from the division.

18. The wavefront measuring method according to claim 17, further comprising:
irradiating a sample with the electromagnetic wave pulse; and
obtaining information associated with the sample by detecting the electromagnetic wave pulse from the sample.
